(19) United States
(12) Patent Application Publication
(10) Pub. No.: US 2014/0179222 A1
(43) Pub. Date: Jun. 26, 2014

(54) Method and system for effective and efficient service support

(71) Applicants: Vishal Chaudhary, Chennai (IN); Takameren Longkumer, Chennai (IN); Vidya Kanigiluppai Sivasubramanian, Chennai (IN)

(72) Inventors: Vishal Chaudhary, Chennai (IN); Takameren Longkumer, Chennai (IN); Vidya Kanigiluppai Sivasubramanian, Chennai (IN)

(21) Appl. No.: 13/723,230

(22) Filed: Dec. 21, 2012

(51) Int. Cl. H04B 5/00

(52) U.S. Cl. CPC H04B 5/0031
USPC 455/41.1

(57) ABSTRACT

A method and a system for effective and efficient service support provided by the OEM are disclosed. The method provides a Ubiquitous Support Platform (USP) that enables the user or the on-field service personnel to interact with the remote support service centre and/or the R&D teams of the OEM using a mobile device. A secure device or secure software or a programmed NFC tag is integrated in the equipment. The mobile device with audio-video support, communication capability, a mobile software application providing device specific and value added services is disclosed. Thus, the method provides enhanced customer satisfaction and enhanced overall service experience.

The present application is based on, and claims priority from, IN Application Number 4572/CHE/2012, filed on 29 Oct. 2012, the disclosure of which is hereby incorporated by reference herein.

### TECHNICAL FIELD

The embodiments herein relate to technical service support systems and more particularly to enhanced machine to machine, human to human and human and machine interactions.

### BACKGROUND

The need of support services has gained tremendous importance over the years. Today's user expects prompt, round the clock service from an organization. Enterprises/organizations strive hard to provide a platform where user's queries can be directed for prompt and accurate resolution. Equipment manufacturers (EM's), Original Equipment Manufacturers (OEM's), enterprises and organizations providing support for products/equipments, need to provide technical service support to the user for necessary technical assistance and troubleshooting. OEM is a company whose products are used by other company in its own product. The OEM will generally work closely with the company that sells the finished product. The technical support for equipments may be required at multiple levels. In order to provide prompt and effective support the multi-tier support system should work efficiently both in terms of the process and execution.

Typically in a equipment support ecosystem, the end users are supported by the immediate technical support team of the user's organization and any further higher level assistance if required, is provided by the EM with help of a dedicated remote support center, a field service personnel and/or experts from the Research and Development (R&D) teams of the EM or the Original Equipment Manufacturer (OEM). For any issues/problems faced by the equipment, user need to capture the problems and communicate the same to the remote service support for assistance and resolution is cumbersome. In most of the cases, the exact problem faced by the user may not be communicated effectively. Quite often, the equipment problem may not be clearly identified even after several interactions between the user and the remote service support centre.

Understanding the exact problem and finding the root cause remains one of the biggest challenges in such scenarios. The problem scenarios may get lost due to time gap in the problem occurrence and problem reporting. If the issues remain unresolved, OEMs are often forced to involve service experts and/or R&D and may send them to the field for equipment inspection. Field service personnel often go to the field without proper understanding of the issues. Otherwise, they tend to carry more spare parts than necessary or may not carry the right part. Such factors push up the cost of troubleshooting and introduce delays complaint call closing. Also, increase in the OEM service costs reduces profit margins. This results in equipment downtime, which adversely impacts user's revenue, dissatisfaction and finally tarnishes OEM brand equity.

Existing methods addresses the above hurdles by providing user with remote support for problem diagnosis and use a mobile device for communicating with the remote support personnel. Some existing methods allow access to equipment database for issue related information but fail to provide secure, authenticated information exchange between the mobile device and the equipment under repair. Conventional methods include software that provides only text chat to support real time troubleshooting by the remote service support staff.

In light of above discussion, a method and system that provides prompt, enhanced technical service support with secured and authenticated access to the equipment information and database will be appreciated.

### BRIEF DESCRIPTION OF THE FIGURES

The embodiments herein will be better understood from the following detailed description with reference to the drawings, in which:

FIG. 1 illustrates components of a Ubiquitous Support Platform (USP) that provides efficient and effective service support, according to embodiments disclosed herein;

FIG. 2 illustrates a flow diagram explaining the process of remote service support using USP, according to embodiments disclosed herein; and

FIG. 3 illustrates a computing environment implementing the application, according to embodiments disclosed herein.

### SUMMARY

Accordingly the embodiment provides a method for providing an optimal service support for an equipment by an enterprise, wherein the method comprises identifying a mobile device in the vicinity of the equipment, authenticating the mobile device based on at least one information associated with the equipment, establishing connection with the mobile device after the authentication, capturing issues associated with the equipment using the mobile device, sending the issues to the enterprise in a communication network by the mobile device and resolving the issues by the enterprise after analyzing the issues.

Accordingly the embodiment provides a system for providing an optimal service support for an equipment by an enterprise, wherein the system comprises a Ubiquitous Support Platform (USP), an equipment, a enterprise database, communication network, wherein the system is configured to identify a mobile device in the vicinity of the equipment, authenticate the mobile device based on at least one information associated with the equipment, establish connection with the mobile device after the authentication, capture issues associated with the equipment using the mobile device, send the issues to the enterprise in a communication network by the mobile device and resolve the issues by the enterprise after analyzing the issues.

Accordingly the embodiment provides a mobile device for communicating with an equipment and an enterprise, wherein the mobile device comprises an integrated circuit further comprising at least one processor, at least one memory having a computer program code within the circuit, the at least one memory and the computer program code configured to with the at least one processor cause the mobile device to capture issues associated with the equipment and send the issues to the enterprise in a communication network.

### DETAILED DESCRIPTION OF EMBODIMENTS

The embodiments herein and the various features and details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and a system for effective and efficient technical service support provided by the OEM. The method provides a Ubiquitous Support Platform (USP) that enables the user or the on-field service personnel to efficiently and effectively interact with the remote support centre and/or the R&D teams of the OEM to better understand the issues associated with the equipment. The USP enables the OEM to resolve the on-field equipment issues in time and cost effective manner by optimizing machine to machine, human to human, and human to machine interactions. OEM represents any enterprise or organization. The USP may comprise a secure device, secure software, and a programmed NFC tag installed on the equipment. The USP also comprises a mobile device with audio-video support, communication capability, a mobile software application providing device specific and value added services. The mobile device also has a collaboration system that enables one to one or multiparty video, audio and text chat interactions. The method disclosed addresses the security and privacy issues of the equipment connectivity and data transfer to external authenticated servers (OEM servers) or devices in a mobile manner. Thus, the method provides enhanced customer satisfaction and overall service experience.

In an embodiment, the mobile device can be a handheld mobile phone, a tablet, a laptop, a personal digital assistant (PDA), an electronic notepad, a gaming device or console, a digital camera, a media player and so on.

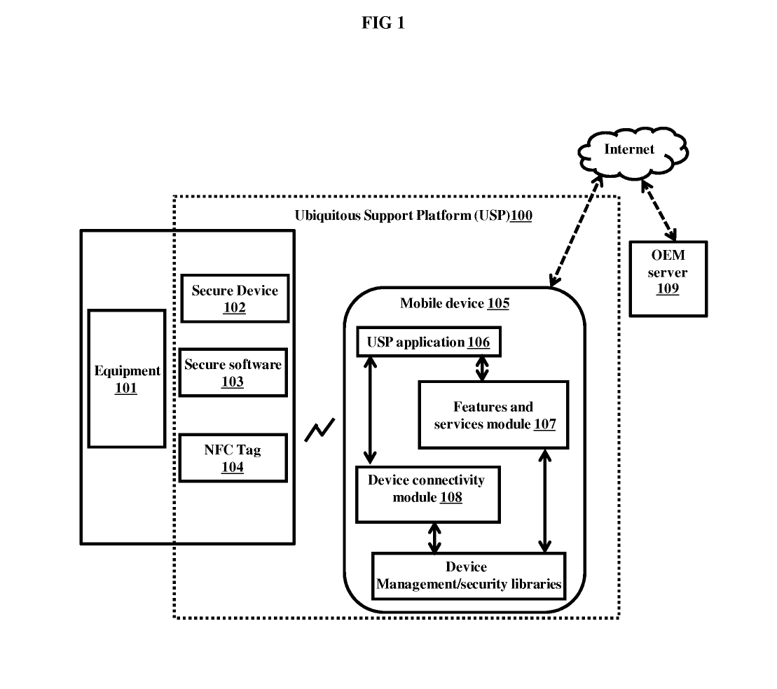

Referring now to the drawings, and more particularly to FIGS. 1 through 3, where similar reference characters denote corresponding features consistently throughout the figures, there are shown embodiments.

FIG. 1 illustrates components of a Ubiquitous Support Platform (USP) that provides efficient and effective service support, according to embodiments disclosed herein. The figure depicts a USP 100, equipment 101 and an OEM server 109. The USP 100 comprises any of the components such as a secure device 102, secure software 103 and a Near Field communication (NFC) tag 104 incorporated on the equipment 101. Further, the USP comprises a mobile device 105 which further includes a USP application 106, a features and service module 107, a device connectivity module 108 supported by device management and/or security libraries. The USP 100 disclosed enables the OEM's to provide effective and efficient service support demanded by on-field equipment 101. The equipment 101 can be a product that needs on-field technical support at various levels.

In an embodiment, the equipment 101 can be heavy electro mechanical equipments, Magnetic resonance imaging (MRI) machines, In Vitro Diagnostic (IVD) equipments, power plant equipments, oil and gas equipments, water treatment and recycling equipment, aeronautical equipments, mail automation equipments, automotive factory equipments, textile factory equipments and so on.

The secure device 102 which can be hardware module with embedded software. The secure device 102 can be integrated in the equipment 101 which communicates with the mobile device 105 using wired or wireless connectivity. The secure device 102 uniquely identifies the equipment 101 and authenticates the mobile device 105.

The USP 100 comprises the secure software 103 that includes a software library and resides on the equipment 101. The secure software 103 executes instructions to enable exchange of secured information of the equipment 101 with the mobile device 105 after establishing a wired or wireless connection. The secure software 103 uniquely identifies the equipment 101 and authenticates the mobile device 105.

The USP 100 also comprises the NFC tag 104 on the equipment 101. It is a programmed NFC tag. The NFC tag 104 holds a unique identifier and information of the equipment 101 such as equipment serial number, unique identification code and so on. The equipment information is encrypted and then stored to provide security. Thus, NFC tag 104 tag enables establishing a unique connection between the equipment 101 and the mobile device 105.

In an embodiment, the wireless connectivity can be infrared, Bluetooth, NFC, Bluetooth LE, Radio Frequency, and Wireless Fidelity (Wi-Fi) and so on. In an embodiment, wired connectivity can be a wired interface such as a Universal Asynchronous Receiver/Transmitter (UART), Universal Serial Bus (USB), Local Area Network (LAN), Controller Area Network (CAN), and Ethernet and so on.

The OEM implements the disclosed method at different stages of equipment lifecycle. In a new product development scenario, any of the secure device 102, secure software 103 or NFC tag 104 can be integrated in the equipment 101. In cases where existing equipments support wired or wireless connectivity, the method enables equipment 101 to connect to an external secure device 102 or the external secure software 103 or use the NFC tag 104. In case of existing (already in market) equipments that are unable to support any form of connectivity, still can use the benefits of USP 100 by using the NFC tag 104 or other wireless technologies like Radio-frequency identification (RFID) and the like to establish connection with the mobile device 105.

The USP 100 uses the ubiquitous mobile technology. This enables the mobile device 105 to provide real time telepresence of remote service support centre personnel, whenever user of equipment 101 makes a service request call. The handheld mobile device 105 includes the USP application 106 supported with features and services module 107 and device connectivity module 108. The USP application 106 provides various equipment specific and value added services. The features and services module 107 provides a video camera that enables video recording or conferencing and streaming of the current working condition of the equipment 101 to the remote service support personnel. The features and service module 107 comprises inbuilt audio speakers and microphone for audio communication between on-field user of the equipment 101 and the remote support centre personnel. The device connectivity module 108 enables connection establishment of the mobile device 105 with either of the secure device 102, the secure software 103, the NFC 105 wirelessly. The mobile device 105 connects to the remote service support centre through the OEM server 109.

The device connectivity module 108 supports cellular network and data access using any of the General packet radio service (GPRS), Global System for Mobile Communications (GSM), 2G, 3G, 4G communication and the like. Once the connection is established between the mobile device 105 and OEM sever 109, the collaboration software module of the features and services module 107 enables video, voice and text chat interactions.

The method enables authenticated access to the OEMs server 109 through the mobile device 105. Thus, based on authentication and subscription level of user, he/she is provided unlimited access to the OEM's 109 knowledgebase and intranet, including complete logs of previous cases (associated with the particular product type) from across the world.

In an embodiment, the USP application 106 can also communicate with a Customer Relationship Management (CRM). The CRM is a widely implemented model for managing a company's (enterprise's) interactions with customers (users), clients, and sales prospects. In an embodiment, the mobile device 105 and the OEM server 109 communicate using internet or Wi-Fi network.

Multiple stake holders such as remote service support personnel, R&D team members are connected to the OEM server 109 to provide higher level service support from the remote end. The collaboration module enables one to one or multiparty intercommunication between the equipment 101 user and remote service support personnel.

The user of the mobile device 105 can either be the equipment operator, or visiting on-field service personnel or visiting senior service personnel or any other authorized personnel. The method provides additional services for equipment support based on the authentication and subscribed service level of the user. The additional services provided include but are not limited to user manuals, user service reports, latest schematics and equipment diagrams, immediate and previous service/maintenance logs of the equipment 101. All these additional services can be accessed through the mobile device 105.

Thus the mobile device 105 enables better time utilization for the remote service support personnel by using of the telepresence feature to detect the issue associated with the equipment 101. The method enables real time video and audio interaction and chats to take place between the remote service support personnel and the user of the on-field equipment 101. Thus, user can recreate fault scenario of the equipment 101, which can be supervised by remote service support personnel using the video and audio communications. This enables the remote service support personnel to provide effective and efficient root-cause analysis and triage. These necessary actions can be carried out by the user without negating the warranty and service clauses under authorized guidance from OEM remote service support personnel. The real time audio-video support enables remote service support personnel to carefully observe any display of alarms/info texts, symbols or indications, can hear any relevant noises/sounds from the equipment 101. Thus, the method enables better understanding of the actual problem associated with the equipment 101 and assists in triage and rapid troubleshooting at a much earlier stage. This eventually reduces the OEM's service cost by reducing travel costs for on-field service support personnel. The method also improves customer satisfaction by enabling quick resolution of issues and reducing the downtime of equipment 101. Thus, method reduces the Mean Time to Repair (MTTR) which provides measure of maintainability and is a composite performance measure dependent on maintenance management systems. MTTR represents the average time required to repair a failed component or equipment.

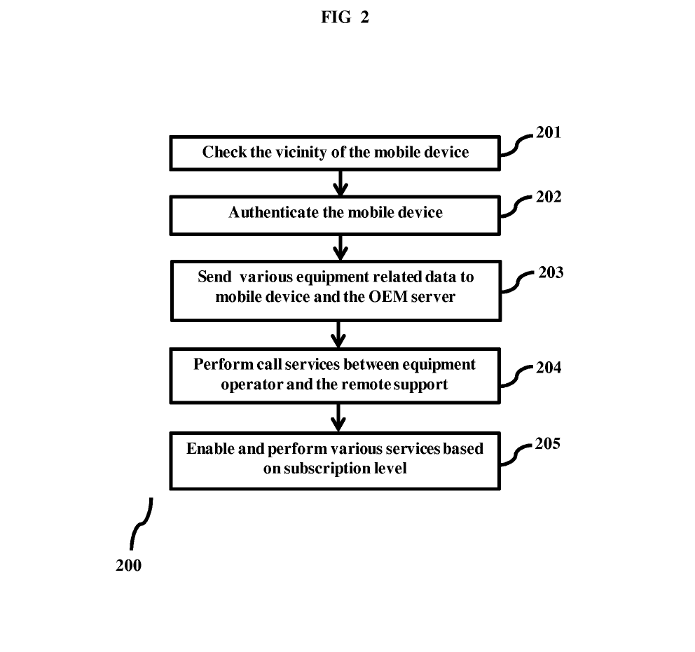

FIG. 2 illustrates a flow diagram explaining the process of remote service support using USP, according to embodiments disclosed herein. The equipment 101 needs service support from the OEM. The user of the mobile device 105 can be the equipment operator. The equipment 101 can have one of the secure device 102 or the secure software 103 or the NFC tag 104, which communicates with the mobile device 105 wirelessly. For example, the secure device 102 is integrated in the equipment 101. Then the secure device 102 checks (201) the proximity of the mobile device 105. The secure device 102 activates as soon as it detects mobile device 105 in the vicinity. The secure device 102 authenticates (202) the mobile device 105 by exchanging equipment serial number and equipment unique identification code stored in the secure device 102. Upon successful authentication, secure device 102 automatically sends (203) the equipment information such as serial number, other unique information to the mobile device 105 and the OEM server 109. The above process is executed when the on-field equipment operator requests for support from the remote service support connected to the OEM server 109. Upon establishment of communication between the equipment operator and the remote service support personnel, various call services as required are performed (204). The service support personnel at the remote center use the equipment information received by the OEM server 109 to access all the immediate and historic information of the equipment 101. This equipment information can be accessed from the OEM database at the OEM server 109. This equipment information provides the remote service support personnel greater contextual awareness of the equipment history and the issues with the equipment 101. The method enables (205) and performs various services based on subscription level of the user. The various actions in method 200 may be performed in the order presented, in a different order or simultaneously. Further, in some embodiments, some actions listed in FIG. 2 may be omitted.

In an embodiment, if the equipment related issues are not troubleshot with call services performed between the equipment operator and the remote service support personnel, the field service support personnel can personally visit the field. The method enables the on-field service support personnel to attend the service call 101 with better understanding of the equipment issues, along with likely spares and solutions. The field service support personnel can interact with the experts and R&D teams (if required) for triage and root cause analysis through one to one or multiparty interaction as required. The mobile device 105 enables the on-field service support personnel to access all the immediate and previous service/maintenance logs of the equipment on the mobile device 105. The method provides access to the equipment database based on the level of the personnel or user.

The mobile device 105 captures the video of the equipment 101 and transfer the video over the internet to the OEM server 109. The stake holders connected with the OEM server 109 know the issues associated with the equipment 101.

In an embodiment, the real-time video, audio and text collaboration sessions can be recorded in the remote service support center. This enables capturing of equipment issues and recording of critical sequence of steps that causes the equipment issues. Such and similar recordings can be very useful for training and any escalations at the OEM.

In an embodiment, if the mobile device 105 is lost, the method enables to remotely wipe away the sensitive data of the equipment 101 stored in the mobile device 105 and ensures data security and privacy.

For example, MRI in the hospitals provides great depth of information in patient body. If such MRI is down for any amount of time, then it becomes difficult to the hospital or scan labs to diagnose patients. Failure of any major component in the MRI equipment shuts down the equipment. The equipment operator struggles to restart the MRI equipment. In such scenarios, the disclosed method enables the equipment operator to start the USP application installed in his/her mobile device. As soon as the MRI equipment equipped with NFC tag detects a mobile device in the vicinity, it authenticates the mobile device. On authentication, the mobile device (USP application) which provides communication with OEM sever and sends the equipment serial number, unique identification code to the OEM remote service support. The equipment operator can make connection to the OEM's remote support center and can provide/upload the information in written form, an audio recording or a video recording using the mobile device. This enables for easier understanding of the problem by the OEM's remote service support desk. Thus, remote service support can instruct the equipment operator to carry on few basic procedures for trouble shooting under their live supervision.

If the issue remains unresolved, then the OEM's remote service support sends the field service engineer for inspection. The method enables the field service engineer to visit the field location with better knowledge of the situation. The on-field service personnel can access the equipment's service history, the user manuals and the schematic diagrams from the OEM' s server database with help of the mobile device. If the on-field service personnel detects certain unique, new issues in the MRI equipment and requests the R&D team abroad to help handle the issue. The R&D team abroad better understands the issue with help of the live video streaming of faulty equipment. The on-field service personnel is instructed accordingly and receives live guidance and supervision while trouble shooting the issue on field.

Thus, the method disclosed enables quick support from R&D team without need for them to travel to the field. The method enables higher percentage of first-time-right (call center) analysis and resolutions. The method also enables a leaner call center by reducing the frequency of level one calls requiring human intervention.

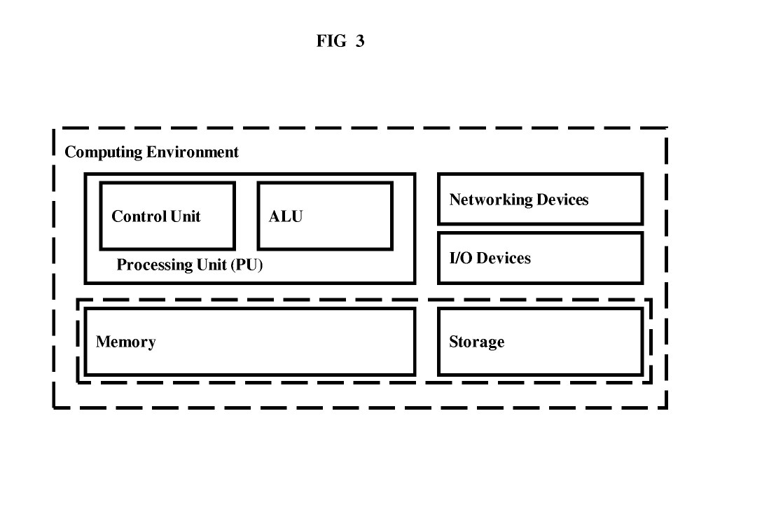

FIG. 3 illustrates a computing environment implementing the application, according to embodiments disclosed herein. As depicted the computing environment comprises at least one processing unit that is equipped with a control unit and an Arithmetic Logic Unit (ALU), a memory, a storage unit, plurality of networking devices, and a plurality Input output (I/O) devices. The processing unit is responsible for processing the instructions of the algorithm. The processing unit receives commands from the control unit in order to perform its processing. Further, any logical and arithmetic operations involved in the execution of the instructions are computed with the help of the ALU.

The overall computing environment can be composed of multiple homogeneous and/or heterogeneous cores, multiple CPUs of different kinds, special media and other accelerators. The processing unit is responsible for processing the instructions of the algorithm. The processing unit receives commands from the control unit in order to perform its processing. Further, any logical and arithmetic operations involved in the execution of the instructions are computed with the help of the ALU. Further, the plurality of process units may be located on a single chip or over multiple chips.

The algorithm comprising of instructions and codes required for the implementation are stored in either the memory unit or the storage or both. At the time of execution, the instructions may be fetched from the corresponding memory and/or storage, and executed by the processing unit.

In case of any hardware implementations various networking devices or external I/O devices may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 and 3 include blocks which can be at least one of a hardware device, or a combination of hardware device and software module.

The embodiment disclosed herein specifies a system for Ubiquitous Support Platform (USP). The mechanism allows a common platform providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for providing an optimal service support for an equipment by an enterprise, wherein said method comprises:
identifying a mobile device in the vicinity of said equipment;
authenticating said mobile device based on at least one information associated with said equipment;
establishing connection with said mobile device after said authentication;
capturing issues associated with said equipment using said mobile device;
sending said issues to said enterprise in a communication network by said mobile device; and
resolving said issues by said enterprise after analyzing said issues.

2. The method as in claim 1, wherein said equipment comprises at least one of:
secure device, secure software, and Near Field Communication (NFC) tag.

3. The method as in claim 2, wherein said at least one of: secure device, secure software, NFC tag communicates with said mobile device using at least one of: infrared, Bluetooth, Wi-Fi, radio frequency, NFC, LAN, CAN, serial.

4. The method as in claim 1, wherein said information comprises equipment serial number, unique identification code.

5. A system for providing an optimal service support for an equipment by an enterprise, wherein said system comprises a Ubiquitous Support Platform (USP), an equipment, a enterprise database, communication network, wherein said system is configured to:
identify a mobile device in the vicinity of said equipment;
authenticate said mobile device based on at least one information associated with said equipment;
establish connection with said mobile device after said authentication;
capture issues associated with said equipment using said mobile device;
send said issues to said enterprise in a communication network by said mobile device; and
resolve said issues by said enterprise after analyzing said issues.

6. The system as in claim 5, wherein said USP comprises a mobile device, further said mobile device comprises: an USP application, features and service module, device connectivity module, device management libraries.

7. The system as in claim 5, wherein said database comprises at least one of:
equipment history, immediate and previous maintenance logs of said equipment, latest schematics and equipment diagrams.

8. The system as in claim 5, wherein said equipment, said USP, said database communicates with one another using said communication network, wherein said communication network comprises at least one of: infrared, Bluetooth, Wi-Fi, internet, radio frequency, NFC, LAN, CAN, serial.

9. The system as in claim 5, wherein said equipment comprises at least one of: a secure device, secure software, a NFC tag.

10. The system as in claim 5, wherein said system enables secured transfer of said issues by at least one of: live video, audio, text chat to said enterprise.

11. The system as in claim 5, wherein said system is configured to authenticate a user of said mobile device to provide access to said database based on the subscription service level of said user.

12. A mobile device for communicating with an equipment and an enterprise, wherein said mobile device comprises:
an integrated circuit further comprising at least one processor;
at least one memory having a computer program code within said circuit;
said at least one memory and said computer program code configured to with said at least one processor cause said mobile device to:
capture issues associated with said equipment; and
send said issues to said enterprise in a communication network.

13. The mobile device as in claim 12, wherein said mobile device is configured to capture at least one of: video, audio information of said equipment and send said information to said enterprise.

14. The mobile device as in claim 13, wherein said communication network comprises at least one of: GPRS, second generation (2G), third generation (3G), fourth generation (4G), Wi-Fi.

15. The mobile device as in claim 12, wherein said mobile device is configured to collaborate at least one: one to one, multiparty interaction between user and the remote service support, wherein said multiparty interaction comprises at least one of: audio, video, text chat.
